(19) United States
(12) Patent Application Publication
(10) Pub. No.: US 2025/0164518 A1
(43) Pub. Date: May 22, 2025

(54) APPARATUS FOR ESTIMATING LEGAL VELOCITY OF VEHICLE AND METHOD FOR THE SAME

(71) Applicants: Hyundai Motor Company, Seoul (KR); Kia Corporation, Seoul (KR); KONGJU NATIONAL UNIVERSITY INDUSTRY-UNIVERSITY COOPERATION FOUNDATION, Gongju-si (KR)

(72) Inventors: Min Sang SEONG, Yongin-Si (KR); Jong Seok OH, Cheonan-Si (KR); Gyu Yong HWANG, Cheonan-Si (KR)

(73) Assignees: Hyundai Motor Company, Seoul (KR); Kia Corporation, Seoul (KR); KONGJU NATIONAL UNIVERSITY INDUSTRY-UNIVERSITY COOPERATION FOUNDATION, Gongju-si (KR)

(21) Appl. No.: 18/634,644

(22) Filed: Apr. 12, 2024

(30) Foreign Application Priority Data
Nov. 21, 2023 (KR) 10-2023-0162503

(51) Int. Cl. G01P 3/00; G01P 15/02

(52) U.S. Cl. CPC G01P 3/00; G01P 15/02

(57) ABSTRACT

An apparatus for estimating a lateral velocity of a vehicle and a method for the same are provided to estimate the lateral velocity of the vehicle with higher accuracy, and to be applied to an electronic stability program (ESP) device to improve the driving stability of the vehicle, by including a long short-term memory (LSTM) model trained to estimate the lateral velocity of the vehicle, obtaining a longitudinal velocity, a lateral acceleration, and a yaw rate of the vehicle, and estimating the lateral velocity of the vehicle, which corresponds to the longitudinal velocity, the lateral acceleration, and the yaw rate of the vehicle, based on the LSTM model.

### CROSS-REFERENCE TO RELATED APPLICATION

The present application claims priority to Korean Patent Application No. 10-2023-0162503, filed on Nov. 21, 2023, the entire contents of which is incorporated herein for all purposes by this reference.

### BACKGROUND OF THE PRESENT DISCLOSURE

### Field of the Present Disclosure

The present disclosure relates to a technology for estimating a legal velocity of a vehicle, based on a long short-term memory (LSTM) provided in a multiple input single output (MISO) type.

### Description of Related Art

In general, Deep Learning (Deep Neural Network) is one type of machine learning and includes an artificial neural network (ANN) with multiple layers between an input and an output. The ANN may include a convolution neural network (CNN) or a recurrent neural network (RNN) depending on architectures, a problem to be solved, and an object.

Data input into the CNN is classified into a training set and a test set. The CNN learns a weight of the neural network through the training set and verifies the training result through the test set.

In such a CNN, when data is input, operations are gradually performed from an input layer to a hidden layer and the results of the operations are output. In the present procedure, the input data passes through all nodes only once.

The passing of the data through all the nodes only once refers to that the CNN includes an architecture which is not based on a data sequence, that is, in a time aspect. Accordingly, the CNN performs training regardless of the time sequence of input data. Meanwhile, the RNN has an architecture in which the result of the hidden layer is input into the hidden layer again. Such an architecture refers to considering the time sequence of the input data.

However, the RNN is degraded in a training ability, as the input data is longer. This refers to an issue of long dependency. In RNN, as the length between the input data and an output is increased, the correlation between the input data and the output is decreased, and the dependency on the past information is present to obtain a present answer. However, in RNN, the time interval between a past time point and a present time point is significantly long, so that the issue of the dependency may not be difficult to be resolved.

To resolve the issue of the long dependency, the LSTM model has been suggested. The LSTM model has three gates and two states, in other words, a forget gate, an input gate, and an output gate, and a cell state and a hidden state.

Meanwhile, the velocity of the vehicle is divided into a longitudinal velocity and a lateral velocity. However, when the vehicle drives along a straight road, the longitudinal velocity and the lateral velocity are dependent on each other. However, when the vehicle drives along a curved road, the longitudinal velocity and the lateral velocity are dependent on each other.

Although the longitudinal velocity of the vehicle may be directly measured through a wheel speed sensor, the lateral velocity of the vehicle may be difficult to be directly measured and thus mainly requires the use of an estimating technology based on an approximate model.

According to the technology of estimating the lateral velocity of the vehicle, in which the lateral velocity of the vehicle is estimated based on the longitudinal velocity of the vehicle, the specifications of the vehicle, and a tire characteristic, the error may be caused when the slip angle of the wheel is increased due to the nonlinear of the tire and the yaw behavior of the vehicle.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus for estimating a lateral velocity of a vehicle and a method for the same, configured for estimating the lateral velocity of the vehicle with higher accuracy, by including a long short-term memory (LSTM) model trained to estimate the lateral velocity of the vehicle, obtaining a longitudinal velocity, a lateral acceleration, and a yaw rate of the vehicle, and estimating the lateral velocity of the vehicle, which corresponds to the longitudinal velocity, the lateral acceleration, and the yaw rate of the vehicle, based on the LSTM model, and of being applied to an electronic stability program (ESP) device to improve the driving stability of the vehicle.

Another aspect of the present disclosure provides an apparatus for estimating a lateral velocity of a vehicle and a method for the same, configured for determining a longitudinal velocity of the vehicle based on a wheel speed sensor, obtaining a lateral acceleration and a yaw rate of the vehicle from an inertial measurement unit (IMU) sensor, and estimating the lateral velocity of the vehicle, based on the longitudinal velocity, the lateral acceleration, and the yaw rate of the vehicle, estimating the lateral velocity of the vehicle, and of being applied to an electronic stability program (ESP) device to improve the driving stability of the vehicle.

Another aspect of the present disclosure provides an apparatus for estimating a lateral velocity of a vehicle and a method for the same, configured for determining whether a wheel slip state occurs, using a longitudinal velocity of the vehicle and a longitudinal acceleration of the vehicle, estimating the lateral velocity of the vehicle, based on the longitudinal velocity of the vehicle, a lateral acceleration of the vehicle, and a yaw rate of the vehicle when the wheel slip does not occur, estimating a final longitudinal velocity of the vehicle, using the longitudinal velocity of the vehicle and the longitudinal acceleration of the vehicle, when the wheel slip of the vehicle occurs, and estimating the lateral velocity of the vehicle, based on the final longitudinal velocity of the vehicle, the lateral acceleration of the vehicle, and the yaw rate of the vehicle, estimating the lateral velocity of the vehicle with the higher accuracy, and of being applied to an electronic stability program (ESP) device to improve the driving stability of the vehicle

The technical problems to be solved by the present disclosed are not limited to the aforementioned problems, and any other technical problems not mentioned herein will be clearly understood from the following description by those skilled in the art to which the present disclosure pertains. Furthermore, it may be easily understood that the objects and the features of the present disclosure are realized by means and the combination of the means claimed in appended claims.

According to an aspect of the present disclosure, an apparatus for estimating a lateral velocity of a vehicle, may include a storage to store a long short-term memory (LSTM) model in a multiple input single output (MISO) type, and a controller to obtain a longitudinal velocity, a lateral acceleration, and a yaw rate of the vehicle, and estimate the lateral velocity of the vehicle, which corresponds to the longitudinal velocity, the lateral acceleration, and the yaw rate, based on the LSTM model.

According to an exemplary embodiment of the present disclosure, the controller may further obtain the longitudinal acceleration of the vehicle and determine whether a wheel slip of the vehicle occurs, by use of the longitudinal velocity and the longitudinal acceleration.

According to an exemplary embodiment of the present disclosure, the controller may estimate the lateral velocity of the vehicle, based on the longitudinal velocity of the vehicle, the lateral acceleration of the vehicle, and the yaw rate of the vehicle, when the wheel slip of the vehicle does not occur.

According to an exemplary embodiment of the present disclosure, the controller may estimate a final longitudinal velocity of the vehicle, using the longitudinal velocity of the vehicle and the longitudinal acceleration of the vehicle, and estimate the lateral velocity of the vehicle, based on the final longitudinal velocity, the lateral acceleration, and the yaw rate, when the wheel slip of the vehicle occurs.

According to an exemplary embodiment of the present disclosure, the controller may determine whether the wheel slip of the vehicle occurs, based on a difference between a variation in the longitudinal velocity and the longitudinal acceleration.

According to an exemplary embodiment of the present disclosure, the controller may determine whether the wheel slip of the vehicle occurs, based on a differential value of the longitudinal velocity.

According to an exemplary embodiment of the present disclosure, the controller may determine the longitudinal velocity of the vehicle, through a wheel speed sensor operatively connected to the controller.

According to an exemplary embodiment of the present disclosure, the controller may determine the longitudinal velocity of the vehicle by applying a tire model of the vehicle to a rotation velocity of a wheel of the vehicle, which is measured through a wheel speed sensor operatively connected to the controller.

According to an exemplary embodiment of the present disclosure, the controller may obtain the lateral acceleration and the yaw rate of the vehicle from an inertial measurement unit (IMU) sensor operatively connected to the controller.

According to another aspect of the present disclosure, a method for estimating a lateral velocity of a vehicle, may include storing, by a storage, a long short-term memory (LSTM) model in a multiple input single output (MISO) type, obtaining, by a controller, a longitudinal velocity, a lateral acceleration, and a yaw rate of the vehicle, and estimating, by the controller, the lateral velocity of the vehicle, which corresponds to the longitudinal velocity, the lateral acceleration, and the yaw rate, based on the LSTM model.

According to an exemplary embodiment of the present disclosure, the obtaining of the longitudinal velocity, the lateral acceleration, and the yaw rate of the vehicle may include obtaining, by the controller, the longitudinal acceleration of the vehicle.

According to an exemplary embodiment of the present disclosure, the estimating of the lateral velocity of the vehicle may include determining whether a wheel slip of the vehicle occurs, by use of the longitudinal velocity and the longitudinal acceleration, estimating, by the controller, the lateral velocity of the vehicle, based on the longitudinal velocity, the lateral acceleration, and the yaw rate, when the wheel slip of the vehicle does not occur, and estimating a final longitudinal velocity of the vehicle, using the longitudinal velocity of the vehicle and the longitudinal acceleration of the vehicle, and estimating the lateral velocity of the vehicle, based on the final longitudinal velocity, the lateral acceleration, and the yaw rate, when the wheel slip of the vehicle occurs.

According to an exemplary embodiment of the present disclosure, the determining of whether the wheel slip of the vehicle occurs may include determining, by the controller, whether the wheel slip of the vehicle occurs, based on a difference between a variation in the longitudinal velocity and the longitudinal acceleration.

According to an exemplary embodiment of the present disclosure, the determining of the whether the wheel slip of the vehicle occurs may include determining, by the controller, whether the wheel slip of the vehicle occurs, based on a differential value of the longitudinal velocity.

According to an exemplary embodiment of the present disclosure, the obtaining of the longitudinal velocity, the lateral velocity, and the yaw rate of the vehicle may include determining, by the controller, the longitudinal velocity of the vehicle, through a wheel speed sensor operatively connected to the controller.

According to an exemplary embodiment of the present disclosure, the deterring of the longitudinal velocity of the vehicle may include determining, by the controller, the longitudinal velocity of the vehicle by applying a tire model of the vehicle to a rotation velocity of a wheel of the vehicle, which is measured through a wheel speed sensor operatively connected to the controller.

According to an exemplary embodiment of the present disclosure, the obtaining of the longitudinal velocity, the lateral velocity, and the yaw rate of the vehicle may include obtaining, by the controller, the lateral acceleration and the yaw rate of the vehicle from an inertial measurement unit (IMU) sensor operatively connected to the controller.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a block diagram illustrating an apparatus for estimating a lateral velocity of a vehicle, according to an exemplary embodiment of the present disclosure;

FIG. 2 is a view exemplarily illustrating an LSTM model in a MISO type provided in an apparatus for estimating a lateral velocity of a vehicle, according to an exemplary embodiment of the present disclosure;

FIG. 3 is a view exemplarily illustrating a process of determining a longitudinal velocity of a vehicle by a controller provided in an apparatus for estimating a lateral velocity of the vehicle, according to an exemplary embodiment of the present disclosure;

FIG. 4 is a block diagram illustrating a method for estimating a lateral velocity of a vehicle, according to an exemplary embodiment of the present disclosure; and

FIG. 5 is a block diagram illustrating a computing system to execute a method for estimating a lateral velocity of a vehicle, according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to accompanying drawings. In adding the reference numerals to the components of each drawing, it should be noted that the identical or equivalent component is designated by the identical numeral even when they are displayed on other drawings. Furthermore, in the following description of an exemplary embodiment of the present disclosure, a detailed description of well-known features or functions will be ruled out in order not to unnecessarily obscure the gist of the present disclosure.

In describing the components of the exemplary embodiment of the present disclosure, terms such as first, second, “A”, “B”, “(a)”, “(b)”, and the like may be used. These terms are merely intended to distinguish one component from another component, and the terms do not limit the nature, sequence or order of the constituent components. Furthermore, unless otherwise defined, all terms used herein, including technical or scientific terms, include the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

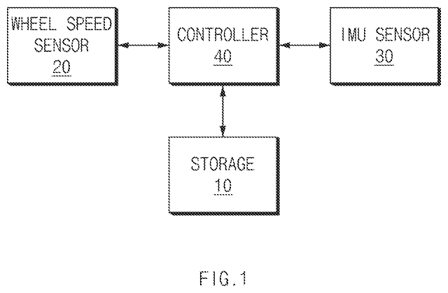

FIG. 1 is a block diagram illustrating an apparatus for estimating a lateral velocity of a vehicle, according to an exemplary embodiment of the present disclosure.

As illustrated in FIG. 1, according to an exemplary embodiment of the present disclosure, the apparatus for estimating the lateral velocity of the vehicle includes a storage 10, a wheel speed sensor 20, an inertial measurement unit (IMU) sensor 30, and a controller 40. In the instant case, according to an exemplary embodiment of the present disclosure, the components may be combined into each other to be implemented in one form, or some components may be omitted, depending on the manners of reproducing the apparatus for estimating the lateral velocity of the vehicle.

Regarding the components, first, the storage 10 may store a long short-term memory (LSTM) model in a multiple input single output (MISO) type which receives a longitudinal velocity, a lateral acceleration, and a yaw rate of the vehicle and is trained to output a lateral velocity corresponding to the longitudinal velocity, the lateral acceleration, and the yaw rate of the vehicle. In the instant case, the LSTM model is a deep-learning model.

The storage 10 may store various logic, various algorithms, and various programs required in a process of obtaining the longitudinal velocity, the lateral acceleration, and the yaw rate of the vehicle, and estimating the lateral velocity of the vehicle, which corresponds to the longitudinal velocity, the lateral acceleration, and the yaw rate of the vehicle, based on the LSTM model.

The storage 10 may store various logic, various algorithms, and various programs required in a process of determining the longitudinal velocity of the vehicle, through the wheel speed sensor 20, obtaining the lateral acceleration and the yaw rate of the vehicle through the IMU sensor 30, and estimating the lateral velocity of the vehicle, which corresponds to the longitudinal velocity, the lateral acceleration, and the yaw rate of the vehicle, based on the LSTM model.

The storage 10 may store various logic, various algorithms, and various programs required in a process of determining whether a wheel slip state occurs, using the longitudinal velocity of the vehicle and the longitudinal acceleration of the vehicle, and estimating the lateral velocity of the vehicle, based on the longitudinal velocity of the vehicle, the lateral acceleration of the vehicle, and the yaw rate of the vehicle when the wheel slip does not occur.

The storage 10 may store various logic, various algorithms, and various programs required in a process of determining whether a wheel slip state occurs, using the longitudinal velocity of the vehicle and the longitudinal acceleration of the vehicle, and estimating a final longitudinal velocity of the vehicle, using the longitudinal velocity of the vehicle and the longitudinal acceleration of the vehicle, when the wheel slip of the vehicle occurs, and estimating the lateral velocity of the vehicle, based on the final longitudinal velocity of the vehicle, the lateral acceleration of the vehicle, and the yaw rate of the vehicle.

The storage 10 may store various logic, various algorithms, and various programs required in a process of estimating the lateral velocity of the vehicle, based on the final longitudinal velocity, the lateral acceleration, and the yaw rate of the vehicle, and transmitting the lateral velocity of the vehicle to an electronic stability program (ESP) device of the vehicle, improving the driving stability of the vehicle.

The wheel speed sensor 20 may be provided in the vehicle to measure the rotation velocity (that is, the rotation angular speed) of the wheel.

The IMU sensor 30 may measure the lateral acceleration and the yaw rate of the vehicle. For reference the IMU, which is a device to measure, based on a sensor, a velocity, a direction gravity, and an acceleration of a moving object, an X-axis acceleration (the longitudinal acceleration of the vehicle), a Y-axis acceleration (the lateral acceleration of the vehicle), and a Z-axis acceleration (the vertical acceleration of the vehicle). The IMU sensor 30 may measure a roll angular speed, a yaw angular speed, and a pitch angular speed based on a 3-axis angular sensor.

The controller 40 is electrically connected to the components, and may perform the overall control operation so that the components normally perform the intrinsic operations thereof. The controller 40 may be implemented in the form of hardware, software, or the combination of hardware and software. The controller 40 may be implemented using a micro-processor, but the present disclosure is not limited thereto.

The storage 40 may store various logic, various algorithms, and various programs required in a process of obtaining the longitudinal velocity, the lateral acceleration, and the yaw rate of the vehicle, and estimating the lateral velocity of the vehicle, which corresponds to the longitudinal velocity, the lateral acceleration, and the yaw rate of the vehicle, based on the LSTM model.

In the instant case, the controller 40 may be configured to determine the longitudinal velocity of the vehicle, through the wheel speed sensor 20, and may obtain the lateral acceleration and the yaw rate of the vehicle from the IMU sensor 30. In the instant case, the controller 40 may be configured to determine the longitudinal velocity of the vehicle by applying the tire model of the vehicle to a rotation speed of the wheel, which is measured by the wheel speed sensor 20.

In addition, the controller 40 may be configured to determine whether a wheel slip occurs, using the longitudinal velocity and the longitudinal acceleration of the vehicle. In the instant case, the controller 40 may be configured to determine whether the wheel slip occurs, based on the difference between the variation in the longitudinal velocity of the vehicle and the longitudinal acceleration, or may be configured to determine whether the wheel slip occurs, based on the size of the differential value of the longitudinal velocity of the vehicle.

Furthermore, the controller 40 may estimate the lateral velocity of the vehicle, based on the longitudinal velocity of the vehicle, the lateral acceleration of the vehicle, and the yaw rate of the vehicle, when the wheel slip does not occur.

Furthermore, the controller 40 may estimate a final longitudinal velocity of the vehicle, using the longitudinal velocity of the vehicle and the longitudinal acceleration of the vehicle, and estimate the lateral velocity of the vehicle, based on the final longitudinal velocity, the lateral acceleration, and the yaw rate of the vehicle, when the wheel slip of the vehicle occurs.

Furthermore, the controller 40 may estimate the lateral velocity of the vehicle, based on the final longitudinal velocity, the lateral acceleration, and the yaw rate of the vehicle, and transmit the lateral velocity of the vehicle to an electronic stability program (ESP) device of the vehicle, improving the driving stability of the vehicle. In the instant case, the lateral velocity of the vehicle may be utilized to a human machine interface (HMI).

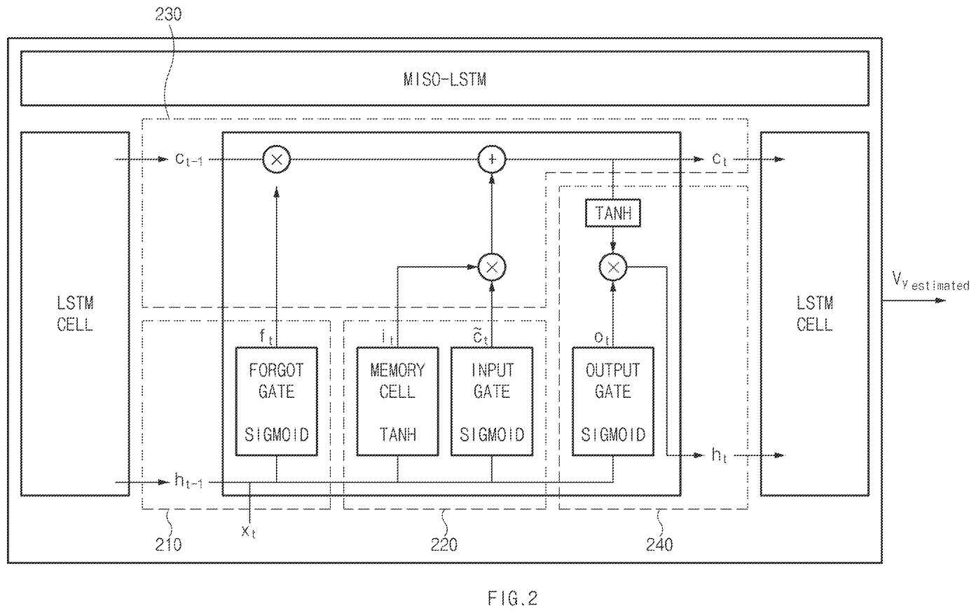

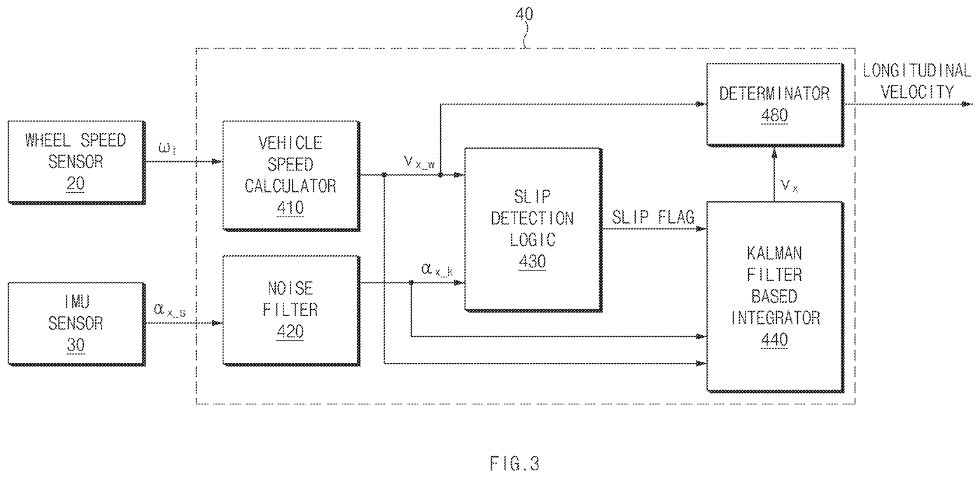

Hereinafter, the operation of the controller 40 will be described in detail with reference to FIG. 2 and FIG. 3.

FIG. 2 is a view exemplarily illustrating an LSTM model in a MISO type provided in an apparatus for estimating a lateral velocity of a vehicle, according to an exemplary embodiment of the present disclosure.

In FIG. 2, hₜ represents a hidden state, cₜ represents a cell state, and xₜ represents input data (the longitudinal velocity, the lateral acceleration, and the yaw rate of the vehicle).

As illustrated in FIG. 2, the LSTM model in the MISO type may include a forgot gate layer 210, an input gate layer 220, a cell state 230, and an output gate layer 240.

In a first stage of the LSTM, the forgot gate layer 210 is configured to determine information, which is to be discarded, from information stored in the cell state 230, based on a function of ‘sigmoid’. In the instant case, the forgot gate layer 210 receives hₜ₋₁ and xₜ, and outputs a value of fₜ between ‘0’ and ‘1, which serves as a measure for information transmission. The value fₜ is multiplied by cₜ₋₁ in the cell state 230. Accordingly, when the value fₜ is ‘1’, all information is preserved. When the value fₜ is ‘0’, all information is discarded. This may be expressed as in following Equation 1.

In a next stage, the input gate layer 220 is configured to determine information, which is to be stored in the cell state 230, from among the input information. In the instant case, \tilde{c}ₜ refers to a candidate activation vector, and iₜ refers to an input gate vector at time step t.

In a next stage, the cell state 230 generates a present cell state cₜ by updating a past cell state cₜ₋₁.

In a final stage, the output gate layer 240 is configured to determine information to be output in a hidden state. In the instant case, oₜ refers to an output gate vector at time step t, and hₜ refers to a hidden state.

Meanwhile, the LSTM model in the MIMO type may estimate the longitudinal velocity and the lateral velocity of the vehicle. However, when compared to the LSTM model in a MISO type, the LSTM model in the MIMO type requires a long training time and a large amount of training data. Accordingly, the LSTM model in the MISO type may be more suitable for vehicle environment in which the resource is limited, as compared to the LSTM model in the MIMO type.

FIG. 3 is a view exemplarily illustrating a process of determining a longitudinal velocity of a vehicle by a controller provided in an apparatus for estimating a lateral velocity of the vehicle, according to an exemplary embodiment of the present disclosure.

As illustrated in FIG. 3, the controller 40 may include a vehicle speed calculator 410, a noise filter 420, a slip detection logic 430, a Kalman filter based integrator 440, and a determinator 480 for the longitudinal velocity.

The vehicle speed calculator 410 may be configured to determine the longitudinal velocity v_{x_w} by applying the tire model of the vehicle to the rotation velocity ωₜ of the wheel which is measured by the wheel speed sensor 20.

In the instant case, the tire model may include an aspect ratio (AR), a tire width (W), a tire diameter (D), a tire height (H), or a tire angular velocity v_w which serves as information on a tire mounted on the vehicle.

The vehicle speed calculator 410 of the vehicle may be configured to determine the longitudinal velocity v_{x_w} of the vehicle, through the following Equation 1.

$${v}_{x \_ w} = r \times v\_w \qquad Equation 1$$

In the instant case,

$$r = 0.98 \times r\_w , r\_w = \frac{d\_w}{2 \times 1000} , d\_w = D + ( 2 \times H ) , H = \frac{( AR \times W )}{100}$$

are satisfied.

The noise filter 420 may remove noise from the longitudinal acceleration α_{x_s} of the vehicle, which is measured by the IMU sensor 30.

The slip detection logic 430 may detect the slip of the wheel based on the longitudinal velocity v_{x_w} of the vehicle, which is determined by the vehicle speed calculator 410, and the longitudinal acceleration α_{x_k} of the vehicle, which has no noise through the noise filter 420.

The Kalman filter based integrator 440 may estimate the longitudinal velocity Vₓ of the vehicle, in which the slip of the wheel is reflected, based on the longitudinal velocity V_{x_w} of the vehicle and the longitudinal acceleration α_{x_k} of the vehicle. In the instant case, the longitudinal velocity v_{x_w} of the vehicle has a larger error in a behavior in which the slip of the tire or a locking, for example, the sudden starting or the sudden braking of the vehicle. However, the longitudinal velocity Vₓ of the vehicle has a smaller error in a behavior in which the slip of the tire or the locking, for example, the sudden starting or the sudden braking of the vehicle.

The determinator 480 may be configured to determine the longitudinal velocity v_{x_w} as the final longitudinal velocity of the vehicle, when the wheel slip does not occur. When the wheel slip occurs, the determinator 480 may be configured to determine the longitudinal velocity Vₓ of the vehicle as the final longitudinal velocity of the vehicle. In the instant case, the determinator 480 may be configured to determine the longitudinal velocity Vₓ of the vehicle as the final longitudinal velocity of the vehicle. When the longitudinal velocity Vₓ of the vehicle is input from Kalman filter based integrator 440. Alternatively, the determinator 480 may be configured to determine the longitudinal velocity v_{x_w} of the vehicle as the final longitudinal velocity of the vehicle. When the longitudinal velocity Vₓ of the vehicle is not input from Kalman filter based integrator 440.

Meanwhile, various data may be obtained through sensors provided in the vehicle. Accordingly, when the various data is selected as an input factor of the LSTM model, the complexity of the LSTM model is increased. Accordingly, the selection of the input factor is important to improve the performance of the LSTM model. Accordingly, input factors were selected based on correlation analysis with the lateral velocity of the vehicle, which is to be estimated, and a lateral dynamics theory. The selected input factors are the longitudinal velocity, the lateral acceleration, and the yaw rate of the vehicle.

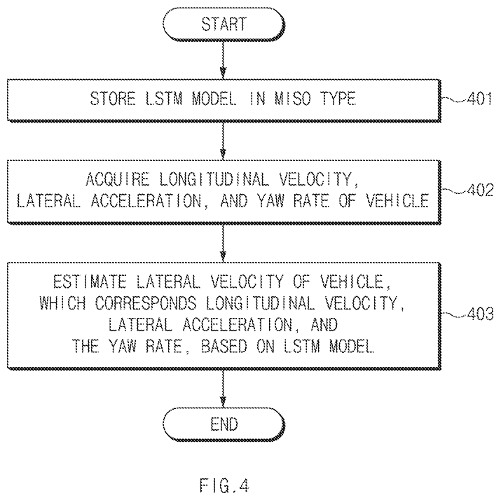

FIG. 4 is a flowchart illustrating a method for estimating a lateral velocity of a vehicle, according to an exemplary embodiment of the present disclosure.

First, the storage 10 stores the LSTM model in the MISO type (401). In the instant case, the LSTM model in the MISO type is a model completed in training.

Thereafter, the controller 40 obtains the longitudinal velocity, the lateral acceleration, and the yaw rate of the vehicle (402).

Thereafter, the controller 40 estimates the lateral velocity of the vehicle, which corresponds the longitudinal velocity, the lateral acceleration, and the yaw rate, based on the LSTM model (403). Further, the controller 40 controls the driving of the vehicle based on the lateral velocity of the vehicle or utilizes the lateral velocity of the vehicle to improve the driving stability of the vehicle.

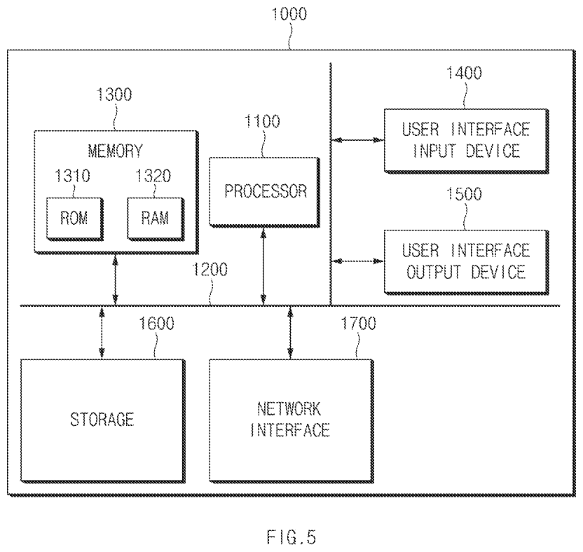

FIG. 5 is a block diagram illustrating a computing system to execute a method for estimating a lateral velocity of a vehicle, according to an exemplary embodiment of the present disclosure.

Referring to FIG. 5, according to an exemplary embodiment of the present disclosure, the method for estimating the lateral velocity of the vehicle may be implemented through the computing system. A computing system 1000 may include at least one processor 1100, a memory 1300, a user interface input device 1400, a user interface output device 1500, a storage 1600, and a network interface 1700, which are connected to each other via a system bus 1200.

The processor 1100 may be a central processing unit (CPU) or a semiconductor device for processing instructions stored in the memory 1300 and/or the storage 1600. Each of the memory 1300 and the storage 1600 may include various types of volatile or non-volatile storage media. For example, the memory 1300 may include a read only memory (ROM; see 1310) and a random access memory (RAM; see 1320).

Thus, the operations of the methods or algorithms described in connection with the exemplary embodiments included in the present disclosure may be directly implemented with a hardware module, a software module, or the combinations thereof, executed by the processor 1100. The software module may reside on a storage medium (i.e., the memory 1300 and/or the storage 1600), such as a RAM, a flash memory, a ROM, an erasable and programmable ROM (EPROM), an electrically EPROM (EEPROM), a register, a hard disc, a removable disc, or a compact disc-ROM (CD-ROM). The exemplary storage medium may be coupled to the processor 1100. The processor 1100 may read out information from the storage medium and may write information in the storage medium. Alternatively, the storage medium may be integrated with the processor 1100. The processor 1100 and storage medium may reside in an application specific integrated circuit (ASIC). The ASIC may reside in a user terminal. Alternatively, the processor 1100 and the storage medium may reside as separate components of the terminal of the user.

The above description is merely an example of the technical idea of the present disclosure, and various modifications and modifications may be made by one skilled in the art without departing from the essential characteristic of the present disclosure. Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed based on the accompanying claims, and all the technical ideas within the scope equivalent to the claims should be included in the scope of the present disclosure.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In the present specification, unless stated otherwise, a singular expression includes a plural expression unless the context clearly indicates otherwise.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for estimating a lateral velocity of a vehicle, the apparatus comprising:
a storage configured to store a long short-term memory (LSTM) model in a multiple input single output (MISO) type; and
a controller operatively connected to the storage and configured to:
obtain a longitudinal velocity, a lateral acceleration, and a yaw rate of the vehicle; and
estimate the lateral velocity of the vehicle, which corresponds to the longitudinal velocity, the lateral acceleration, and the yaw rate, based on the LSTM model.

2. The apparatus of claim 1, wherein the controller is further configured to:
obtain a longitudinal acceleration of the vehicle and determine whether a wheel slip of the vehicle occurs, by use of the longitudinal velocity and the longitudinal acceleration.

3. The apparatus of claim 2, wherein the controller is further configured to:
estimate the lateral velocity of the vehicle, based on the longitudinal velocity of the vehicle, the lateral acceleration of the vehicle, and the yaw rate of the vehicle, in response that the wheel slip of the vehicle does not occur.

4. The apparatus of claim 2, wherein the controller is further configured to:
estimate a final longitudinal velocity of the vehicle, using the longitudinal velocity of the vehicle and the longitudinal acceleration of the vehicle; and
estimate the lateral velocity of the vehicle, based on the final longitudinal velocity, the lateral acceleration, and the yaw rate, in response that the wheel slip of the vehicle occurs.

5. The apparatus of claim 2, wherein the controller is further configured to:
determine whether the wheel slip of the vehicle occurs, based on a difference between a variation in the longitudinal velocity and the longitudinal acceleration.

6. The apparatus of claim 2, wherein the controller is further configured to:
determine whether the wheel slip of the vehicle occurs, based on a differential value of the longitudinal velocity.

7. The apparatus of claim 1, wherein the controller is further configured to:
determine the longitudinal velocity of the vehicle, through a wheel speed sensor operatively connected to the controller.

8. The apparatus of claim 7, wherein the controller is further configured to:
determine the longitudinal velocity of the vehicle by applying a tire model of the vehicle to a rotation velocity of a wheel of the vehicle, which is measured through the wheel speed sensor.

9. The apparatus of claim 1, wherein the controller is further configured to:
obtain the lateral acceleration and the yaw rate of the vehicle from an inertial measurement unit (IMU) sensor operatively connected to the controller.

10. A method for estimating a lateral velocity of a vehicle, the method comprising:
storing, by a storage, a long short-term memory (LSTM) model in a multiple input single output (MISO) type;
obtaining, by a controller operatively connected to the storage, a longitudinal velocity, a lateral acceleration, and a yaw rate of the vehicle; and
estimating, by the controller, the lateral velocity of the vehicle, which corresponds to the longitudinal velocity, the lateral acceleration, and the yaw rate, based on the LSTM model.

11. The method of claim 10, wherein the obtaining of the longitudinal velocity, the lateral acceleration, and the yaw rate of the vehicle includes:
obtaining, by the controller, a longitudinal acceleration of the vehicle.

12. The method of claim 11, wherein the estimating of the lateral velocity of the vehicle includes:
determining, by the controller, whether a wheel slip of the vehicle occurs, by use of the longitudinal velocity and the longitudinal acceleration;
estimating, by the controller, the lateral velocity of the vehicle, based on the longitudinal velocity, the lateral acceleration, and the yaw rate, in response that the wheel slip of the vehicle does not occur; and
estimating, by the controller, a final longitudinal velocity of the vehicle, using the longitudinal velocity of the vehicle and the longitudinal acceleration of the vehicle, and estimating the lateral velocity of the vehicle, based on the final longitudinal velocity, the lateral acceleration, and the yaw rate, in response that the wheel slip of the vehicle occurs.

13. The method of claim 12, wherein the determining of whether the wheel slip of the vehicle occurs includes:
determining, by the controller, whether the wheel slip of the vehicle occurs, based on a difference between a variation in the longitudinal velocity and the longitudinal acceleration.

14. The method of claim 12, wherein the determining of the whether the wheel slip of the vehicle occurs includes:
determining, by the controller, whether the wheel slip of the vehicle occurs, based on a differential value of the longitudinal velocity.

15. The method of claim 10, wherein the obtaining of the longitudinal velocity, the lateral velocity, and the yaw rate of the vehicle includes:
determining, by the controller, the longitudinal velocity of the vehicle, through a wheel speed sensor operatively connected to the controller.

16. The method of claim 15, wherein the determining of the longitudinal velocity of the vehicle includes:
determining, by the controller, the longitudinal velocity of the vehicle by applying a tire model of the vehicle to a rotation velocity of a wheel of the vehicle, which is measured through a wheel speed sensor operatively connected to the controller.

17. The method of claim 10, wherein the obtaining of the longitudinal velocity, the lateral velocity, and the yaw rate of the vehicle includes:
obtaining, by the controller, the lateral acceleration and the yaw rate of the vehicle from an inertial measurement unit (IMU) sensor operatively connected to the controller.
